(19) United States
(12) Patent Application Publication
(10) Pub. No.: US 2012/0304939 A1
(43) Pub. Date: Dec. 6, 2012

(54) STOWABLE RAMP AND METHOD OF USE

(76) Inventor: David A. Grass, Penfield, NY (US)

(21) Appl. No.: 13/589,367

(22) Filed: Aug. 20, 2012

Related U.S. Application Data
(62) Division of application No. 13/024,297, filed on Feb. 9, 2011.
(60) Provisional application No. 61/319,549, filed on Mar. 31, 2010.

(51) Int. Cl. A01K 13/00; A01K 29/00

(52) U.S. Cl. 119/673

(57) ABSTRACT

A stowable ramp configured for use with a pet tub. The ramp comprises an upper section, a lower section and a pair of wheels. The upper section is a substantially rectangular platform whose upper section is hingeably attached to the tub and disposed substantially at the bottom periphery of the tub's opening. The lower section comprises a substantially rectangular platform whose upper edge is hingeably connected to the lower edge of the upper section. Each wheel is disposed at the lower end of the lower section and oriented in such a manner that its axis of rotation is substantially parallel to the axes of rotation of the hinges. At least one finger hold is further provided on each side of the platform and disposed substantially toward the bottom end of the upper section.

### RELATED APPLICATIONS AND PRIORITY CLAIM

This application claims priority to provisional application U.S. Ser. No. 61/319,549 filed Mar. 31, 2010 and non-provisional application U.S. Ser. No. 13/024,297. Said applications are incorporated by reference herein in their entirety.

### BACKGROUND OF THE INVENTION

1. The Field of the Invention The present invention is directed generally to pet tub ramps, and in particular, stowable pet tub ramps.

2. Background Art

Pet tubs are frequently used by pet owners, pet groomers, self-serve dog wash facilities, kennels and veterinarians to conveniently wash animals, especially dogs. A typical pet tub includes an elevated tub body with a raised backsplash wall and a lowered front wall with an opening at one end that facilitates entry and exit of an animal from the tub body. There is typically provided a ramp that helps bridge the opening of the tub body to a floor. The animal is simply led to the ramp so that it can walk up or down the ramp to enter or exit the tub body.

Ramps have been designed in a multitude of sizes and configurations. Ramps may be permanently affixed, removably attached, retractable or stowable. They may also be standalone structures. While simple in construction, a ramp permanently affixed to a tub presents a tripping hazard, takes up valuable space and presents an obstruction when an operator is working in front of the tub. However, removably attached ramps do not lend themselves to simple and fast removal. Some removably attachable ramps have an abutment portion that clings to the tub opening. When removal is desired, the operator is required to use two hands to pick up the ramp and place it out of the way.

Another challenge presented with conventional pet tub ramps is animal management during the pet bathing routine. It is imperative that the operator remains within an arm's length distance to calm the animal or render help in case the animal attempts to jump out of the tub risking injury or strangling by its collar. After positioning an animal in a conventional pet tub, the operator clears his work space to improve access to the animal. In order to remove the ramp's inclined platform support or stair steps, the operator must pick it up or roll it away. This requires the operator to step away from the tub, thus momentarily leaving the animal unattended.

An exemplary stowable ramp is disclosed in U.S. Pat. No. 6,516,752 to Batterton. The swing ramp has an upper end and a lower end. The upper end is pivotably attached under an opening of the tub and the lower end is equipped with two caster wheels. Once an animal has been positioned in the tub, the operator has to then step away from the front of the tub, secure the bottom end of the ramp (either with a hand or foot) and then swing the bottom end to stow the ramp. As such, the operator is required to step away from the front of the tub momentarily for the ramp to be swung. The operator must bend over to reach the middle or bottom end of the ramp in order to swing it around to tuck it under the tub with his hands, or alternatively, if the operator uses his foot, then there is a possibility of losing his balance, especially on a wet floor that is common when washing pets. The ramp must also be short in order to fit under the tub without interfering with plumbing, resulting in the ramp being too steep for many pets to be comfortable or able to use.

Another exemplary stowable ramp is one that is marketed as PetLift Aqua Quest pet tub. The ramp is constructed of two portions, the first one of which is a substantially level ramp. The ramp is supported on four caster wheels and cooperates with a second portion that is inclined and extendable to the floor. The second portion is then pushed back under the tub. When compared to the aforementioned ramp, this ramp requires the additional step of lifting and retracting the second portion inside the first portion before the ramp can be pushed under the tub. This design also requires a ledge where the two sections join, making navigation by pets more difficult. The ramp is capable of being pushed straight back from the front to the rear of a tub. The push-back design requires the operator to move back away from the tub and bend over nearly to the floor to retract or extend, thus requiring a considerable amount of physical effort.

Yet another exemplary stowable ramp is one that is marketed as Groomer's Best Tub. The tub has only one ramp section that pushes back on castors. Since standard-size tubs are 24 inches deep, the ramp length is limited, making it too steep for easy use by many pets.

Thus, there arises a need for a pet tub ramp that does not require an operator to step away from the tub, does not require the additional step of having to lock wheels in order to prevent movement, is easily manipulated using only a finger or a hand in order to erect or stow the ramp and allows greater length so that the ramp incline is not too steep for practical use.

### SUMMARY OF THE INVENTION

The present invention is directed toward a stowable ramp and more specifically, toward a stowable ramp that is easily operable using only one or two fingers. In accordance with the present invention, there is provided a stowable ramp configured for use with a pet tub having a tub body that has an opening for entry and exit of an animal. The stowable ramp comprises an upper section, a lower section and a pair of wheels. The upper section comprises a substantially rectangular platform having an upper edge, a lower edge, two side edges and a pair of side walls. The upper edge of the upper section is hingeably attached to the tub body and disposed below a bottom periphery of the opening. Each of the two side walls of the upper section is disposed on one side edge of the upper section. The lower section comprises a substantially rectangular platform having an upper edge, a lower edge, two side edges and a pair of side walls. The upper edge of the lower section is hingeably connected to the lower edge of the upper section such that the upper edge of the lower section is substantially coaxial with the lower edge of the upper section. Each of the two side walls of the lower section is disposed on one side edge of the lower section. Each wheel is supported at an attachment point which is disposed on a side wall towards the lower edge of the lower section and oriented in such a manner that its axis of rotation is substantially parallel to the axes of rotation of the hinge connecting the lower and upper sections and the hinge attaching the upper section to the tub body. A finger hold is further provided on at least one side wall of the upper section and disposed substantially towards the bottom edge of the upper section. In order to retract an erected ramp, an operator lifts the ramp at the finger hold using one or two fingers such that the bottom section swings towards the tub body and tucks the ramp under the tub body. In order to extend a stowed ramp, the operator again lifts the ramp at the finger hold using one or two fingers such that the bottom section swings away from the tub body causing the upper and bottom sections to come into alignment to form a ramp.

Accordingly, it is a primary object of the present invention to provide a ramp that is simple to erect and simple to stow without having to step away from the front of a tub body to which the ramp is mounted or leave an animal unattended in the tub body.

It is another object of the present invention to provide a ramp that is stowable in a compact fashion while access to the pet tub is desired and one that is easily erected when the ramp is required.

It is another object of the present invention to provide a ramp that is operable by simply using one or two fingers.

It is a further object of the present invention to provide a ramp that is simple in construction, low cost and intuitive to use.

It is a further object of the present invention to provide a ramp that is retrofitable to a variety of structures.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a top perspective view of a pet tub incorporating one embodiment of the present ramp.

FIG. 1A is a side orthogonal sectional view of one embodiment of a hinge connecting the upper section and lower section taken along line AA of FIG. 1, illustrating one exemplary mechanism by which the platforms are erected.

FIG. 2 is a top perspective view of a pet tub incorporating one embodiment of the present ramp illustrating another embodiment of a hinge connecting the upper section and lower section.

FIG. 2A is a partially transparent cross-sectional side orthogonal sectional view of one embodiment of a hinge connecting the upper section and lower section taken along line BB of FIG. 2, illustrating another exemplary mechanism by which the platforms are erected.

FIG. 2B is a partially transparent cross-sectional side orthogonal sectional view of the hinge embodiment of FIG. 2A, illustrating the hinge mechanism when the ramp is not fully erected.

FIG. 3 is a front orthogonal view of a pet tub incorporating one embodiment of the present ramp.

FIG. 4 is a top orthogonal view of one embodiment of the present ramp.

FIG. 4A is a partial top orthogonal view of one embodiment of the securing interface between a side wall of the lower section and a side wall of the upper section.

FIG. 5-8 are side orthogonal views of a pet tub incorporating the present ramp illustrating the steps taken to stow a deployed ramp.

FIG. 9-10 are side orthogonal views of a pet tub incorporating the present ramp illustrating the steps taken to deploy a stowed ramp.

FIG. 11 is a side orthogonal view of one embodiment of the present ramp illustrating its spatial relationship with respect to a pet tub on which the ramp is attached.

FIG. 12 is a side orthogonal partial cross-sectional view of the present ramp illustrating another means of attaching the ramp to the tub body with the ramp erected.

FIG. 13 is a side orthogonal partial cross-sectional view of the present ramp illustrating the means of attaching the ramp to the tub body of FIG. 12 with the ramp stowed.

FIG. 14 is a front orthogonal view of the present ramp illustrating the means of attaching the ramp to the tub body of FIG. 12 with the ramp stowed.

The drawings are not to scale, in fact, some aspects have been emphasized for a better illustration and understanding of the written description.

### PARTS LIST

2—stowable ramp
4—upper section
6—lower section
8—side wall of upper section
9—cutout on side wall of upper section
10—side wall of lower section
10a—groove
10b—tongue
12—platform of upper section
13—lip of platform of upper section
14—platform of lower section
15—lip of platform of lower section
16—finger hold
17—pin securing upper and lower platforms
18—wheel
19—lip interface
20—hinge for attaching ramp to tub
21—overlap hinge
22—hinge for attaching upper section to lower section
23—hinge leaf
24—wheel attachment point
25—hinge leaf
26—tub body
28—floor
30—bottom surface of tub body
32—clearance between floor and tub body
34—length of upper section
36—length of bottom section
37—length of ramp
38—leg support of tub body
40—front wall of tub body
42—rear wall or backsplash of tub body
44—opening of front wall of tub body
46—direction of force applied to ramp
48—gravity axis
50—angle made between upper and lower sections
52—lower edge of side wall of upper section
54—upper edge of side wall of lower section
56—free end of ramp
58—travel direction of lower section once ramp has been lifted from its deployed position
59—travel direction of lower section once ramp has been lifted from its stowed position
60—vertical distance of finger hold from the floor
62—knob
64—retainer ring
66—support plate
68—aperture
70—recess formed at lower edge of upper section
72—recess formed at upper edge of lower section
74—lower edge of upper section
76—upper edge of lower section

### PARTICULAR ADVANTAGES OF THE INVENTION

One of the most significant aspects of the present ramp lies in its mode of operation. It does not require an operator to step away from the tub to which the ramp is installed in order to erect the ramp for an animal's entry to or exit from the tub or to stow the ramp for increased access to the tub. None of the prior art mentioned elsewhere in this specification is capable of stowing without using more time and effort and stepping away to complete. Having an operator in front of the tub body at all times while an animal is placed in the tub ensures that the animal does not attempt to jump out of the tub and risk injury.

The present ramp is simple and safe to operate and it is particularly suitable for one-handed operation. In contrast to prior art ramps, the present ramp does not require the operator to use both hands or a foot to erect or stow the ramp, rather, one or two fingers can capably erect or stow the ramp thereby making it simple and safe to operate.

The present ramp is simple in construction, low cost and intuitive to use. Due to the simplicity in design of the ramp, the number of parts required to build the ramp is limited, thereby resulting in a ramp that is intuitive to operate without training and is low cost due to the limited parts count. The present ramp is also more stable as compared to prior art ramps which can swing or move back when a pet jumps on the ramps, resulting in the pet being frightened and unwilling to use the ramps subsequently.

### DETAILED DESCRIPTION OF A PREFERRED EMBODIMENT

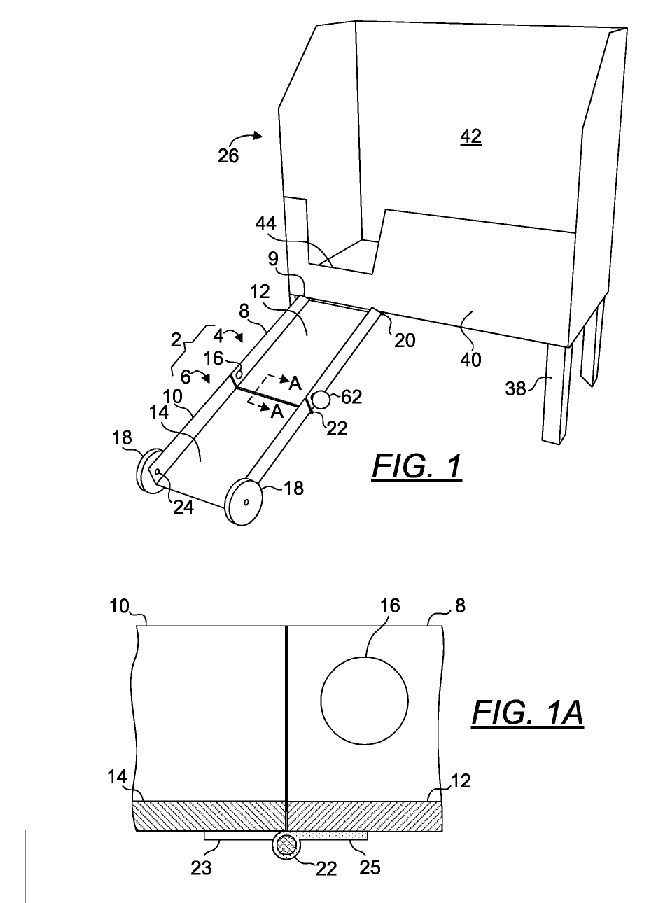

FIG. 1 is a top perspective view of a pet tub incorporating one embodiment of the ramp in its deployed state. As depicted, a ramp 2 is operably attached to a conventional tub body 26 at a location below an opening 44. Although not required, the opening is conventionally disposed towards one lateral side of the front wall 40 of the tub body 26. A raised rear wall 42 serves as a backsplash to prevent spray water from wetting areas behind the tub body 26. It is to be appreciated that the tub opening can also be centrally located. The tub body 26 is a rectangular basin generally disposed at an elevated position to facilitate an operator's access to an animal positioned inside the tub body 26 and ergonomically eliminate the need for excessive bending by the operator. As shown, the tub body 26 is supported on a set of four supporting legs 38 disposed substantially at the four corners of the bottom surface of the tub body 26. The elevated tub body 26 provides sufficient space underneath for stowing the ramp 2. The ramp 2 comprises an upper section 4, a lower section 6 and a pair of wheels 18.

The upper section 4 is an elongated member having a flat and generally rectangular platform 12 with an upper edge, a lower edge and two side edges. The upper edge of the upper section 4 is pivotably attached to the tub body 26, preferably at a location just below the opening 44 of the tub. It can also be mounted elsewhere provided such a mounting location facilitates an animal's entry to and exit from the inside of the tub body 26. As depicted, the upper edge of the upper section 4 is attached to the tub body 26 at the bottom edge of the front wall 40. A pivotal attaching means is provided to secure the upper edge of the upper section to the bottom edge of the front wall. Various pivotal attaching means may be suitably adapted to perform the intended function and are well known in the art. In a preferred embodiment, a hinge 20 is used. In another embodiment (not shown), a pair of hooks is provided on the upper edge of the upper section such that they may be used to “cling” onto the bottom edge of the opening 44.

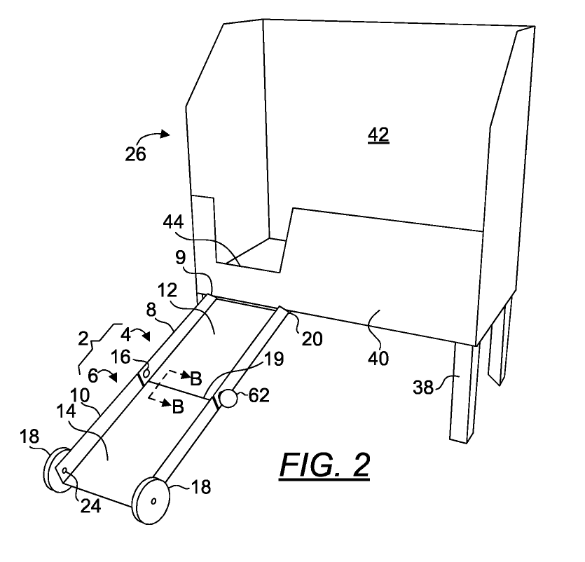

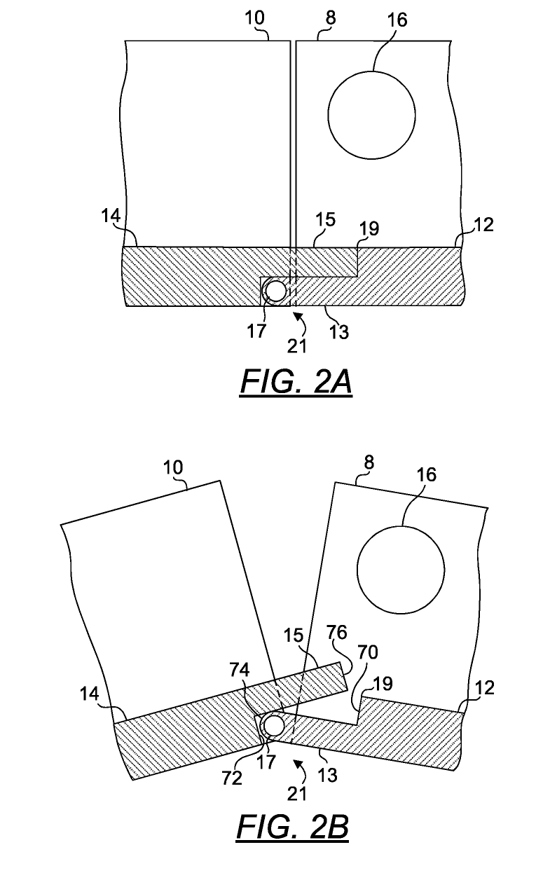

In a preferred embodiment, two side walls 8 are further provided, each disposed on one side edge of the platform 12 to further provide structural rigidity to the platform 12 and provide safety guards to prevent an animal from slipping off a side of the platform 12. At least one finger hold is built into the upper section 4. As depicted, a finger hold in the form of a hole 16 is disposed in one side wall 8 toward the bottom edge of the upper section 4. Various other finger holds may also be used. As shown in FIG. 2, a knob 62 protruding outwardly from one side wall is disposed toward the bottom edge of the upper section 4. A cutout 9 is preferably made to each side wall 8 toward the upper edge of the upper section 4 to accommodate the rotation of the upper section 4 with respect to the tub while the ramp 2 is being deployed or stowed.

The lower section 6 is an elongated member having a flat and generally rectangular platform 14 with an upper edge, a lower edge and two side edges. In the deployed state as shown in FIG. 2, the lower section 6 is pivotably attached to the upper section 4 using a hinge 22 such that the platform 14 is substantially coplanar with the platform 12 of the upper section 4. In one embodiment, hinge 22 is a leaf hinge. In another embodiment, hinge 22 is a piano hinge.

In a preferred embodiment, two side walls 8 are further provided, each disposed on one side edge of the platform 14 to further provide structural rigidity to the platform 14 and provide safety guards to prevent an animal from slipping off a side of the platform 14. The lower section 6 further comprises two wheels 18, each supported at an attachment point 24 which is disposed on a side wall towards the lower edge of the lower section 6 and oriented such that its axis of rotation is substantially parallel to the axis of rotation of hinge 22 and hinge 20. The upper and lower sections do not necessarily require side walls. In one embodiment not shown, the upper section and lower section do not have side walls, but the platforms may be alternately strengthened with well known practices such as using ribs and cross bars.

FIG. 1A is a partially transparent cross-sectional side orthogonal view of the hinge connecting the upper section and lower section taken along line AA of FIG. 1, illustrating one exemplary mechanism by which the platforms are erected and secured by virtue of gravity. Various hinge mechanisms may be used provided that the mechanism is capable of providing sturdy, secure and stable support to an animal using the ramp and one that does not lock hinge 22 in place so that the ramp 2 can be easily stowed without needing to first unlock the hinge 22. Hinge 22 comprises two leaves 23, 25 with leaf 23 attached to the upper edge of the lower section 6 and leaf 25 attached to the lower edge of the upper section 4. In one preferred embodiment, non-slip materials are further disposed over the platform 12, 14 surfaces such that they aid in providing traction to animals, especially when they are wet.

FIG. 2 is a top perspective view of a pet tub incorporating one embodiment of the present ramp illustrating another embodiment of a hinge connecting the upper section and lower section. FIG. 2A is a partially transparent cross-sectional side orthogonal sectional view of one embodiment of a hinge connecting the upper section 4 and lower section 6 taken along line BB of FIG. 2, illustrating another exemplary mechanism by which the platforms are erected. FIG. 2B is a partially transparent cross-sectional side orthogonal sectional view of the hinge embodiment of FIG. 2A, illustrating the hinge mechanism when the ramp is not fully erected. Overlap hinge 21 is formed by overlapping overlap lips 15, 13 of the lower section 6 and the upper section 4 respectively such that the platforms 12, 14 of the upper and lower sections form a substantially flat and continuous surface when the ramp 2 is erected. Recesses 70, 72 are formed on the lower edge 74 of the upper section 4 and the upper edge 76 of the lower section 6, respectively. An apertured joint is formed in the lower edge of the upper section 4. A mating apertured joint is formed in the recess 72 adjacent the upper edge 76 of the lower section 6. A pin 17 is inserted through the two joints to form a secure overlap hinge 21. When erected, the walked upon surface of platforms 12, 14 are rather smooth with only a lip interface 19 showing, thereby not causing distraction to an animal traversing the erected platform.

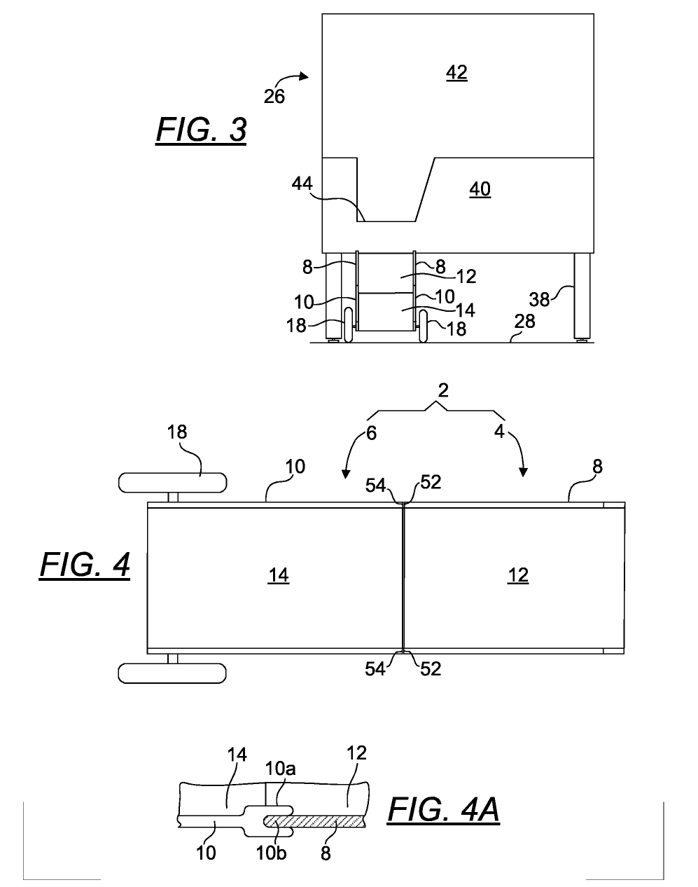

FIG. 3 is a front orthogonal view of the pet tub of FIG. 1. It should be appreciated from this view that, as the ramp is stowed straight back from the front to the back of the tub underneath the tub body 26, there remains space on the right hand side of the ramp underneath the tub body to accommodate tub plumbing and for storing other items. In contrast to the swing type ramps, the present invention is clearly more compact as it does not require the full width of the tub body 26 area for the ramp 2 to be stowed. Additionally, the present invention further prevents potential issues with plumbing under the tub that the swing type ramps can pose. Plumbing is typically disposed on the side of the tub opposite a ramp and the swing type ramps can force the ramp to be configured too short in order to allow adequate space for plumbing when the ramp is disposed under the tub, causing the ramp to be made too steep which results in many dogs being unwilling or unable to use them. In a swing-type ramp, the plumbing (particularly the drain pipes, hair filters and the like) may also be required to be set up in a less convenient way in order to accommodate the ramp.

FIG. 4 is a top orthogonal view of one embodiment of the present ramp. The pivotal engagement shown in FIG. 2 may be additionally secured by bringing the side wall 10 of the lower section at the top edge of the lower section to contacting engagement with the side wall 8 of the upper section. FIG. 4A is a partial top orthogonal view of yet another securing interface between a side wall 10 of the lower section and a corresponding side wall 8 of the upper section. In this embodiment, a tongue and groove combination is used. Referring to FIGS. 4 and 4A, a groove 10a is disposed on the upper edge 54 of a side wall 10 of the lower section 4 while a cooperating tongue 10b is disposed on the lower edge 52 of a side wall 8 of the upper section 6. As will be apparent to those skilled in the art, a groove 10a may alternately be disposed on the lower edge 52 of a side wall 8 of the upper section 4 while a cooperating tongue 10b may be disposed on the upper edge 54 of a side wall 10 of the lower section 6.

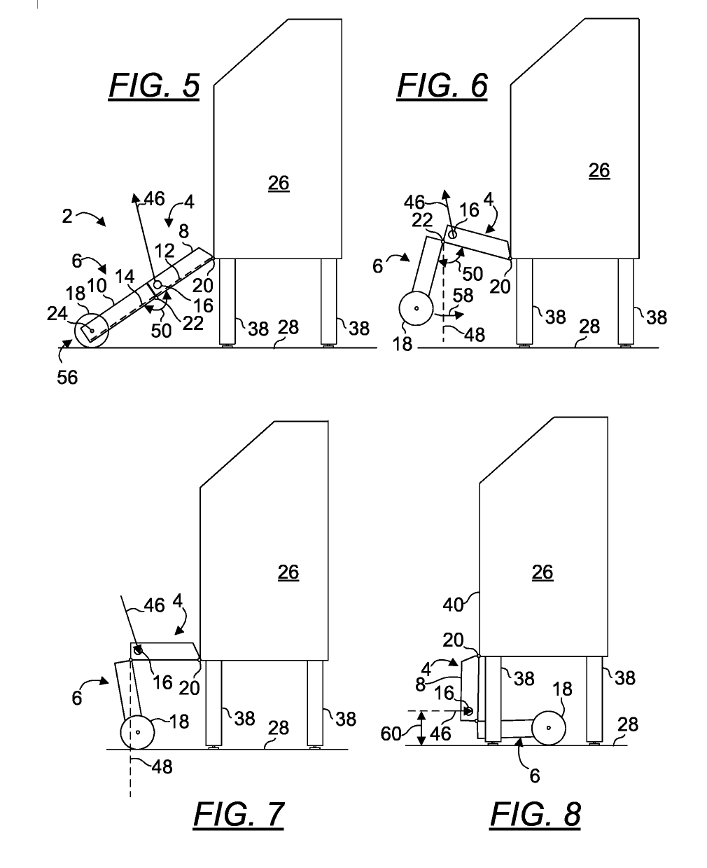

FIG. 5-8 are side orthogonal views of a pet tub incorporating the present ramp illustrating the steps taken to stow a deployed ramp. FIG. 5 depicts a ramp 2 of the present invention operably attached to a tub body 26 elevated on support legs 38 on a floor 28 and disposed in its erected state. The angle 50 made between the platforms of the upper and lower sections is generally 180 degrees in this state. The free end 56 of the ramp 2 rests on the floor 28 due to the ramp's own weight. In order to move the ramp 2 to its stowed position, a force directed generally in the upward direction is first applied to a point disposed at the lower edge of the upper section 4. In a preferred embodiment as shown, the force 46 is applied at the hole 16 disposed on the lower edge of a side wall of the upper section 4. The hole 16 is preferably size to accommodate one or two fingers. As mentioned elsewhere, another equivalent hand hold, for example, a knob may also be used in place of the hole 16.

FIG. 6 depicts an ensuing state of the ramp 2 after the upper section 4 has been lifted. In this state, angle 50 decreases as the lower end of the upper section 4 is lifted up and the lower end of the lower section 6 swings in direction 58 toward the tub body 26 due to momentum, eventually passing the gravity axis 48 to approach the tub body 26. The ramp 2 is then lowered as depicted in FIG. 7. FIG. 7 depicts a state where the ramp 2 is lowered such that the wheels re-contact the floor 28 and the wheels' contact points with the floor 28 are now disposed on the side of the gravity axis closer to the tub body 26. The operator can then proceed to lower the upper section 4 while supported at hole 16 to continue rolling the ramp 2 on wheels 18 toward the cavity underneath the tub body 26. Alternatively, the operator can simply let go and the ramp will come to rest in the stowed position.

FIG. 8 depicts a state where the ramp 2 is in its fully stowed position. The side wall 8 of the upper section protrudes slightly from the front of the tub. In one embodiment (not shown), the side wall of the upper section is fully eliminated and replaced with platform strengthening structures such as ribs disposed on the bottom surface of the platform. In yet another embodiment not shown, the hinge 20 is attached to the bottom surface of the tub body 26 at a location offset from the edge made between the front wall 40 of the tub body 26 and the bottom surface. The vertical distance 60 of the hole 16 from the floor 28 preferably ranges from 3 inches to 9 inches when the ramp is in the stowed position and ranges from 12 inches to 18 inches when the ramp is in the fully erected position. In contrast to the aforementioned prior art ramps, the present invention is simple in construction, uses greatly reduced number of parts, cost effective, simple to operate and with little physical effort, operable using only one or two fingers, operable without having to step backwards leaving the animal in the tub body unattended, operates quietly and is secure and stable in the erected position.

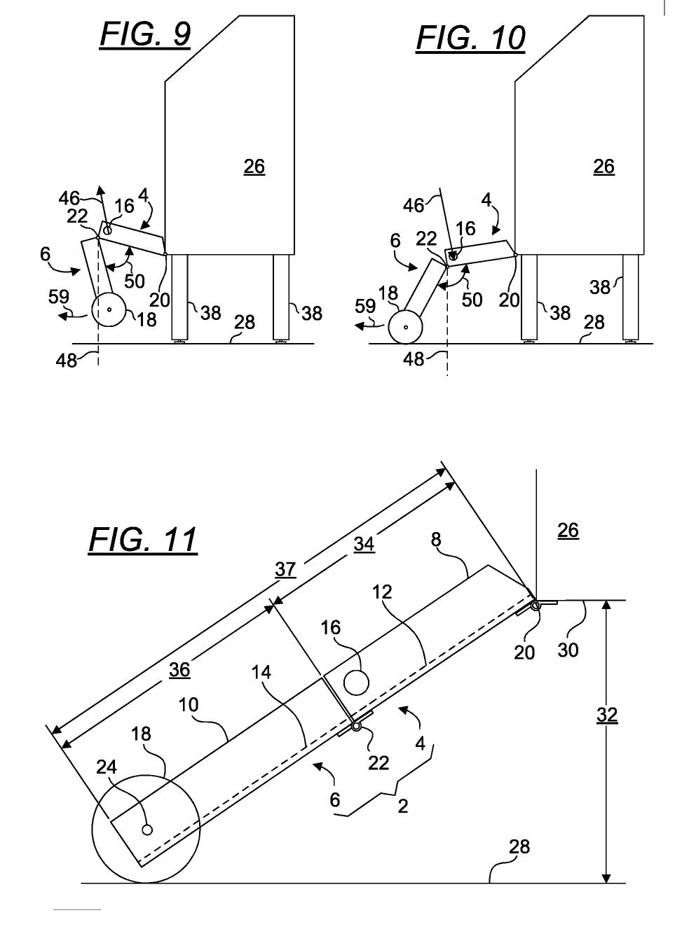

FIG. 9-10 are side orthogonal views of a pet tub incorporating the present ramp illustrating the steps taken to deploy a stowed ramp. FIG. 9 depicts the response of the upper 4 and lower 6 sections when the ramp is lifted at the lower edge of the upper section 4. In this state, angle 50 increases and the lower end of the lower section 6 swings away in direction 59 from the tub body 26 due to gravity and momentum, eventually passing the gravity axis 48 away from the tub body 26. The ramp 2 is then lowered as depicted in FIG. 10. FIG. 10 depicts a state where the ramp 2 is lowered such that the wheels re-contact the floor 28 and the wheels' contact points with the floor 28 are now disposed on the side of the gravity axis away from the tub body 26. The operator can then proceed to lower the upper section 4 while supported at hole 16 and continue rolling the ramp 2 on wheels 18 away from the tub body 26 until the ramp 2 reaches the fully erected state as depicted in FIG. 5. Alternatively, with practice, a user can learn to deploy or stow the ramp 2 while maintaining contact between the wheels 18 and the floor 28.

FIG. 11 is a side orthogonal view of one embodiment of the present ramp illustrating its spatial relationship with respect to a pet tub on which the ramp is attached. Applicant discovered that in order for the ramp 2 to erect and stow satisfactorily, the dimensions of each of the upper and lower sections as compared to the clearance underneath the tub body 26 are of utmost importance. As depicted, the length 37 of the ramp is substantially the sum of the length 34 of the upper section 4 and the length 36 of the lower section 6. The length 37 of the ramp 2 is preferably about twice the height 32 of the clearance between the floor and the bottom surface 30 of the tub body 26. Preferably the ratio of the length 34 of the upper section/the length 36 of the lower section ranges from 0.5 to 0.6.

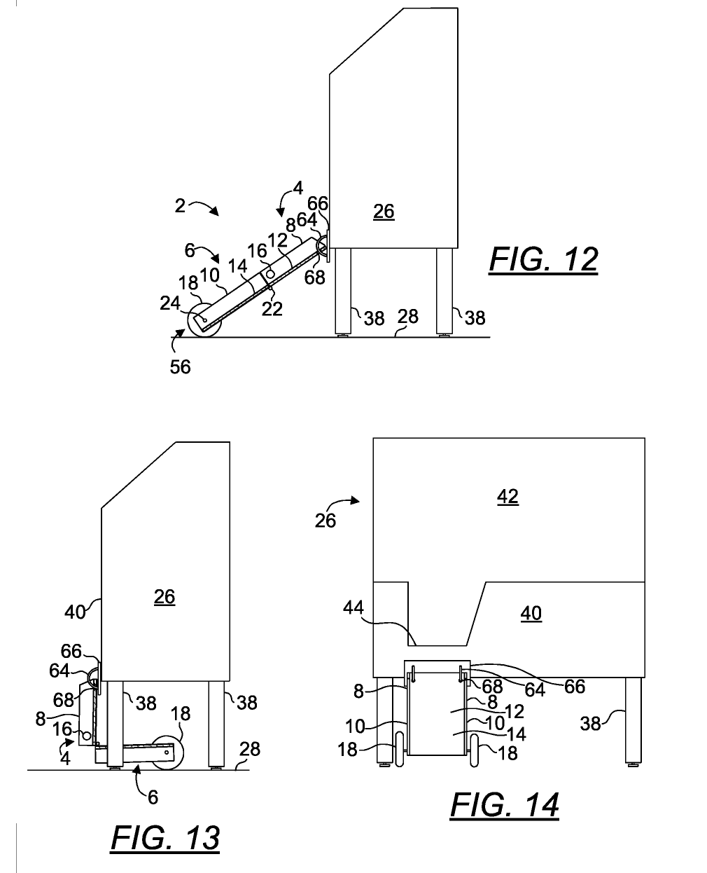

FIG. 12 is a side orthogonal partial cross-sectional view of the present ramp illustrating another means of attaching the ramp to the tub body 26 with the ramp 2 erected. FIG. 13 is a side orthogonal partial cross-sectional view of the present ramp illustrating the means of attaching the ramp to the tub body 26 of FIG. 12 with the ramp 2 stowed. FIG. 14 is a front orthogonal view of the present ramp illustrating the means of attaching the ramp to the tub body 26 of FIG. 12 with the ramp 2 stowed. Referring to FIGS. 12 to 14, a retainer ring 64 is configured for attachment to a support plate 66. The support plate 66 is in turn fixedly secured to the tub body 26 at a location below the opening 44. In this embodiment, a pair of apertures 68 is disposed on corners formed by the upper edge and side edges of the platform 12 of the upper section. In use, a retainer ring 64 is slid through each aperture 68 such that the upper section 4 is rotatably locked in place by the retainer rings 64.

What is claimed is:

1. A pet tub comprising:
an elevated tub having a front edge; and
a stowable ramp configured to bridge a gap between a floor and said elevated tub, said ramp is configured to be mounted to said front edge of said elevated tub and stowable in a clearance underneath said elevated tub, said ramp comprising:
an upper section comprising an elongated platform having an upper surface, a length, an upper edge, a lower edge and two side edges; and
a lower section comprising an elongated platform having an upper surface, a length, an upper edge, a lower edge and two side edges, wherein the ratio of the length of said upper section to the length of said lower section ranges from about 0.5 to 0.6, the lower edge of said upper section is connected to the upper edge of said lower section via a pivoting means having an axis of rotation substantially coaxial to the lower edge of said upper section, said pivoting means further comprises a stopping means so that when said ramp is being erected, said upper section is permitted to rotate with respect to said lower section with a relative angle ranging from a value corresponding to a stowed position of said ramp to a value corresponding to a stopping point imposed by said stopping means and when said ramp is being stowed, said upper section is permitted to rotate with respect to said lower section with a relative angle ranging from a value corresponding to an erected position of said ramp to a value corresponding to said stowed position in a direction substantially perpendicular to said front edge and the lower edge of said lower section comprises a pair of wheels having an axis of rotation substantially parallel to said axis of rotation of said pivoting means.

2. The pet tub of claim 1, wherein the upper edge of said upper section comprises an attaching means.

3. The pet tub of claim 1, further comprising a handhold disposed substantially at the lower edge of said upper section.

4. The pet tub of claim 1, wherein a total length including the length of said upper section and said lower section is about twice the height of the clearance between the floor and the elevated tub.
